(19) United States
(12) Patent Application Publication
(10) Pub. No.: US 2026/0370042 A1
(43) Pub. Date: Nov. 19, 2026

(54) Contactless Power Feeding System

(71) Applicant: Daifuku Co., Ltd., Osaka-shi (JP)

(72) Inventor: Takeshi Hisano, Hinocho (JP)

(21) Appl. No.: 19/678,495

(22) Filed: May 15, 2026

(30) Foreign Application Priority Data
May 16, 2025 (JP) 2025-082618

(51) Int. Cl. H02J 50/12; B60M 7/00; H02J 50/40; H02J 50/70

(52) U.S. Cl. CPC H02J 50/12; H02J 50/40; H02J 50/70; B60M 7/006

(57) ABSTRACT

A contactless power feeding system feeds electric power contactlessly from multiple feed lines aligned in a travel direction of a movable body including a power receiver. The power receiver includes a first receiver coil, a second receiver coil, a first resonator, and a second resonator. The first receiver coil magnetically couples with the feed lines. The second receiver coil is aligned adjacent to the first receiver coil in the travel direction and magnetically couples with the feed lines. The first resonator includes the first receiver coil and a first interference-cancellation coil connected in series to the first receiver coil. The second resonator includes the second receiver coil and a second interference-cancellation coil connected in series to the second receiver coil. The first interference-cancellation coil and the second interference-cancellation coil are disposed to magnetically couple with each other.

### CROSS-REFERENCE TO RELATED APPLICATION

This application claims priority to Japanese Patent Application No. 2025-082618 filed May 16, 2025, the disclosure of which is hereby incorporated by reference in its entirety.

### BACKGROUND OF THE INVENTION

### Field of the Invention

The present invention relates to a contactless power feeding system.

### Description of Related Art

Japanese Unexamined Patent Application Publication No. 2002-67747 describes a power supply system (contactless power feeding system) including multiple induction lines (47), or feed lines through which alternating currents flow, along a travel path for a movable body (V) to supply electric power contactlessly to the movable body (V). In the background, reference signs in parentheses are the reference signs in the above literature. The multiple induction lines (47) are connected to power supplies (inverters (M)) for supplying alternating current power to the induction lines (47). The movable body (V) including a power receiver (pickup coil (5)) travels with electric power supplied contactlessly from the respective induction lines (47) while switching between the multiple induction lines (47). To travel smoothly, the movable body (V) is to be stably powered at switch sections between the induction lines (47) while the power transmission efficiency is being maintained. The power supply system includes a phase-locked loop in an optical transmission device (51) to match the phase of an alternating current flowing through the induction line (47) before switching lines with the phase of a current flowing through the induction line (47) after switching lines.

Although the phase-locked loop may be used, the phases of the currents flowing through all the induction lines are not matched easily. To accurately match the phases with a small error, the phase-locked loop may be formed using a highly accurate device. This is likely to increase the circuit size and the cost. Large facilities include multiple combinations of induction lines and power supply circuits arranged along the travel path for the movable body. A greater number of power supply circuits to be synchronized increases the number of phase-locked loops and wires between the phase-locked loops and the power supply circuits. This increases the cost of the phase-locked loops as well as the installation space for the phase-locked loops and the wires. Contactless power feeding systems with high transmission efficiency at lower cost and on a smaller scale thus remain unachieved.

### SUMMARY OF THE INVENTION

In response to the above, contactless power feeding systems that can transmit electric power with high transmission efficiency with or without a phase difference between alternating currents flowing through multiple feed lines are awaited.

A contactless power feeding system in response to the above includes a movable body including a power receiver, and a plurality of feed lines through each of which an alternating current flows. The plurality of feed lines are aligned in a travel direction along a travel path for the movable body. The contactless power feeding system feeds electric power contactlessly from the plurality of feed lines to the power receiver. The power receiver includes a first receiver coil, a second receiver coil, a first resonator, and a second resonator. The first receiver coil is disposed to magnetically couple with the plurality of feed lines. The second receiver coil is aligned adjacent to the first receiver coil in the travel direction and disposed to magnetically couple with the plurality of feed lines. The first resonator includes the first receiver coil and a first interference-cancellation coil connected in series to the first receiver coil. The second resonator includes the second receiver coil and a second interference-cancellation coil connected in series to the second receiver coil. The first interference-cancellation coil and the second interference-cancellation coil are disposed to magnetically couple with each other.

In this structure, when the movable body travels through a switch portion between the feed lines aligned in the travel direction and one of the first receiver coil or the second receiver coil being disposed between the adjacent feed lines cannot receive power through either of the feed lines, the other receiver coil is likely to receive power from one of the feed lines. This structure allows the power receiver to continuously receive power from a feed line when the movable body travels through the switch portion between the feed lines. However, when the first receiver coil and the second receiver coil are aligned in the travel direction, the first receiver coil and the second receiver coil may electromagnetically interfere with each other, changing the inductances of the first receiver coil and the second receiver coil and lowering power transmission efficiency. This structure including the first interference-cancellation coil and the second interference-cancellation coil that are disposed to magnetically couple with each other reduces electromagnetic interference between the first receiver coil and the second receiver coil, thus preventing a decrease in the power transmission efficiency. In other words, the contactless power feeding system in this structure can transmit electric power with high transmission efficiency with or without a phase difference between the alternating currents flowing through the multiple feed lines.

Further features and advantages of the contactless power feeding system will be apparent from the exemplary and non-limiting embodiments described below with reference to the drawings.

### BRIEF DESCRIPTION OF THE DRAWINGS

FIG. 1 is a plan view of an article transport facility including a contactless power feeding system.

FIG. 2 is a front view of an article transport vehicle.

FIG. 3 is a side view of the article transport vehicle.

FIG. 4 is a schematic circuit block diagram of a power receiver.

FIG. 5 is a schematic block diagram of the contactless power feeding system showing its system configuration.

FIG. 6 is a perspective view of an example switch unit.

FIG. 7 is a diagram of example alternating currents flowing through two feed lines adjacent to each other in a travel direction.

FIG. 8 is a diagram of example currents flowing through receiver coils when the alternating currents flowing through the two feed lines adjacent to each other in the travel direction are in phase.

FIG. 9 is a diagram of example currents flowing through the receiver coils when the alternating currents flowing through the two feed lines adjacent to each other in the travel direction are out of phase.

FIG. 10 is an equivalent circuit diagram of a power transmitter when a first receiver coil and a second receiver coil magnetically couple with the respective two feed lines adjacent to each other in the travel direction.

FIG. 11 is a graph showing a frequency response of received power in the power receiver against capacitance of a resonant capacitor for each phase difference between the alternating currents flowing through the two feed lines adjacent to each other in the travel direction.

FIG. 12 is an equivalent circuit diagram of a power receiver including interference-cancellation coils when the first receiver coil and the second receiver coil magnetically couple with the respective two feed lines adjacent to each other in the travel direction.

FIG. 13 is an equivalent circuit including the first receiver coil and the second receiver coil that magnetically couple with each other.

FIG. 14 is a graph showing the relationship of the phase difference between the currents flowing through the first receiver coil and the second receiver coil with inductances of the first receiver coil and the second receiver coil.

FIG. 15 is an equivalent circuit including the first receiver coil and the second receiver coil that magnetically couple with each other and the first interference-cancellation coil and the second interference-cancellation coil that magnetically couple with each other.

FIG. 16 is a graph showing a frequency response of received power in the power receiver including the first interference-cancellation coil and the second interference-cancellation coil against the capacitance of the resonant capacitor.

### DESCRIPTION OF THE INVENTION

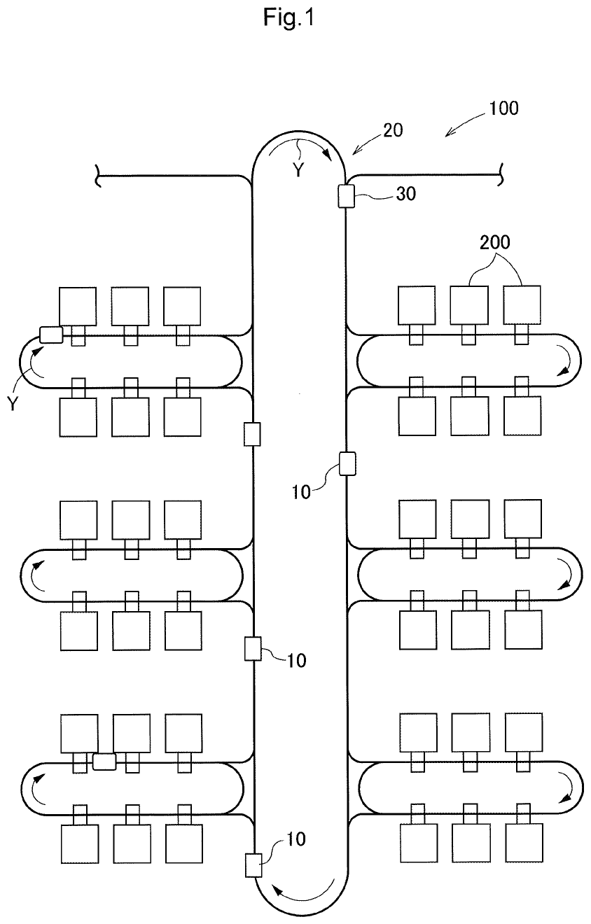

A contactless power feeding system according to an embodiment described below is used as an electric power system for feeding electric power to movable bodies that transport articles in an article transport facility. In the present embodiment, as shown in, for example, FIGS. 1 to 3, each movable body is an article transport vehicle 10 that transports an article by moving along a travel path 20 as travel rails 2 that are hung from the ceiling of a building. The article transport vehicle as the movable body is not limited to a ceiling-hung transport vehicle that travels along the ceiling, and may be a floor-traveling transport vehicle that moves along rails on the floor surface as the travel path 20, a stacker crane, or other article transport vehicles. When such an article transport vehicle includes multiple sections such as a traveler and a body, part of the article transport vehicle, or for example, the traveler alone, may correspond to the movable body, instead of the entire article transport vehicle. For example, for the article transport vehicle being a ceiling-hung transport vehicle as in the present embodiment, a traveler 12 (described later) may correspond to the movable body. For a stacker crane, a crane carrier supporting a crane may correspond to the movable body.

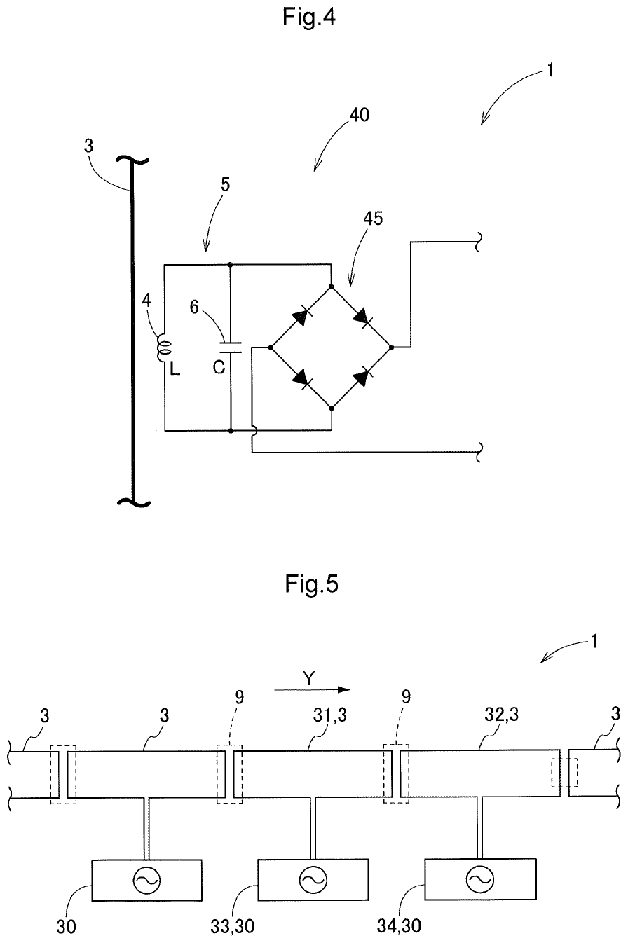

FIG. 1 shows an article transport facility 100 in which a contactless power feeding system 1 (refer to, for example, FIGS. 4 and 5) according to the present embodiment is used. The article transport facility 100 includes the travel rails 2 installed along the travel path 20 on which the article transport vehicles 10 travel, and the article transport vehicles 10 that travel along the travel path 20 as guided by the travel rails 2. In the present embodiment, the article to be transported by each article transport vehicle 10 is, for example, a front-opening unified pod (FOUP) containing semiconductor substrates or a glass substrate for a display. The article transport facility 100 also includes a storage (not shown) for semiconductor substrates, and article processors 200 for performing various processes on the semiconductor substrates, such as forming circuitry.

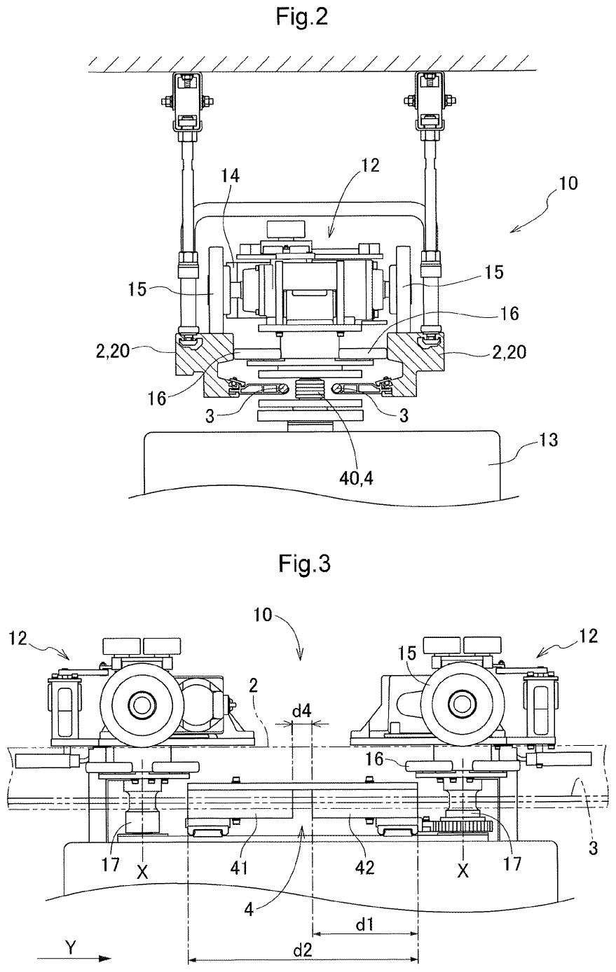

In the present embodiment, the article transport vehicle 10 includes a traveler 12, a body 13, and a power receiver 40, as shown in FIG. 2. The traveler 12 travels along the travel path 20 as guided by a pair of travel rails 2 hung from the ceiling along the travel path 20. The body 13 is below the travel rails 2 and hung from the traveler 12. The power receiver 40 receives driving power contactlessly from feed lines 3 installed along the travel path 20. Although not shown or described in detail, the body 13 includes an article support that is raised or lowered to support an article being hung.

As shown in FIG. 2, the traveler 12 includes a pair of travel wheels 15 that are rotated by an electric drive motor 14. The travel wheels 15 roll on travel surfaces defined by the upper surfaces of the travel rails 2. The traveler 12 includes a pair of guide wheels 16 in contact with the inner surfaces of the pair of travel rails 2. Each guide wheel 16 freely rotates about an axis extending in the vertical direction (vertical axis). The traveler 12 includes, for example, the drive motor 14 for traveling and a drive circuit for the drive motor 14 to allow the article transport vehicle 10 to travel on the travel rails 2. The body 13 includes, for example, an actuator for raising and lowering the article support, an actuator for driving grippers for gripping the articles, and drive circuits for these actuators. The drive motor 14, the actuators, and the drive circuits each correspond to an electric load in the article transport vehicle 10.

In the present embodiment, the article transport vehicle 10 includes two travelers 12 arranged in a travel direction Y as shown in FIG. 3. Each traveler 12 includes a connecting shaft 17 below the travel wheels 15. The connecting shafts 17 connect the respective travelers 12 to the single body 13 common to the two travelers 12. Each connecting shaft 17 connects the corresponding traveler 12 and the body 13 in a manner rotatable relative to each other about a vertical axis X in the vertical direction. As shown in FIG. 1, the travel path 20 includes curves. When the article transport vehicle 10 (traveler 12) travels through the curves, the traveler 12 and the body 13 rotate relative to each other about the connecting shaft 17. This allows the article transport vehicle 10 to smoothly travel through the curves. Pickup coils 4 (described later) are arranged between a first connecting shaft 17 and a second connecting shaft 17 in the travel direction Y.

The article transport facility 100 includes a facility controller (not shown) that transmits a transportation command to the article transport vehicle 10 to transport an article. In response to the transportation command, the article transport vehicle 10 travels autonomously to, for example, transfer and receive an article between an article processor 200 and the article transport vehicle 10, and transports an article between the article processor 200 and the storage described above (not shown).

Electric power for the drive motor 14, the actuators, and the drive circuits for these components is fed contactlessly from the feed lines 3 to the power receiver 40. FIG. 4 is a schematic circuit block diagram of the power receiver 40. FIG. 5 is a schematic block diagram of the contactless power feeding system 1 showing its system configuration. A power supply 30 supplies electric power to the feed lines 3. As described above, the feed lines 3, which feed driving power to the article transport vehicle 10 through the power receiver 40, are installed along the travel path 20. In the present embodiment, the feed lines 3 are arranged on both sides of the power receiver 40 (pickup coils 4 described later) in a path width direction perpendicular to the travel direction Y along the travel path 20 (perpendicular to both the travel direction Y and the vertical direction in this example).

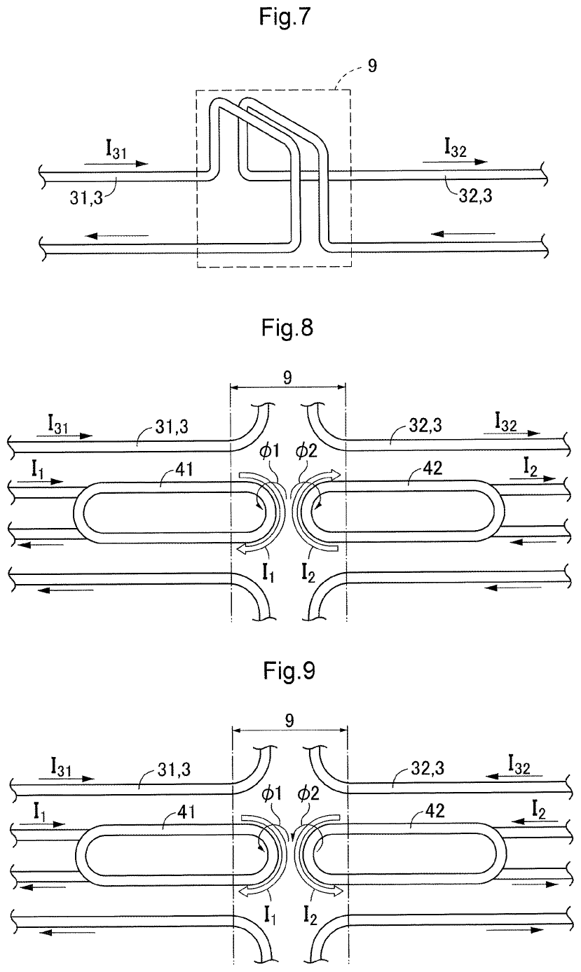

As shown in FIG. 4, the power receiver 40 includes a pickup coil 4 (refer to FIG. 2) disposed in the article transport vehicle 10 to face the feed lines 3, and a power receiver circuit (described in detail later) on a wiring board inside the article transport vehicle 10. The power supply 30 supplies high-frequency currents to the feed lines 3 as induction lines to generate a magnetic field around each feed line 3. The pickup coil 4 generates an induced electromotive force using alternating currents flowing through the feed lines 3. In the present embodiment, the feed lines 3 are arranged on both sides in the path width direction as described above, and the pickup coil 4 faces the feed lines 3 on the both sides in the path width direction. The pair of feed lines 3 arranged on both sides in the path width direction receive electric power from the same power supply 30 as shown in FIG. 5, and have the currents flowing in opposite directions as shown in FIG. 7.

In the present embodiment, a single article transport vehicle 10 (movable body) includes two pickup coils 4 as shown in FIG. 3. More specifically, the pickup coils 4 arranged to magnetically couple with the feed lines 3 include a first receiver coil 41 and a second receiver coil 42 aligned adjacent to each other in the travel direction Y. The first receiver coil 41 and the second receiver coil 42 are aligned adjacent to each other in the travel direction Y between the first connecting shaft 17 and the second connecting shaft 17. The first receiver coil 41 and the second receiver coil 42 have the same electrical characteristics and dimensions, and are arranged in the travel direction Y with a predetermined spacing (a coil spacing d4). The first receiver coil 41 and the second receiver coil 42 are aligned adjacent to each other in the travel direction Y and are apart from each other by a distance based on the coil spacing d4.

When a single article transport vehicle 10 includes a single pickup coil 4, the pickup coil 4 is often disposed between the first connecting shaft 17 and the second connecting shaft 17. In the present embodiment, two receiver coils can be arranged in place of the single pickup coil 4, allowing the mounting configuration of the pickup coils 4 to be changed with the basic structure of the article transport vehicle 10 being maintained. This allows the article transport vehicles 10 in operation to be easily modified. When the article transport vehicles 10 are to be newly manufactured, most of the existing manufacturing facilities can be used. The structure of the article transport facility 100 such as the travel path 20 (travel rails 2) or the feed lines 3 can be used without any change. Thus, the article transport vehicle 10 including a single pickup coil 4 and the article transport vehicle 10 including two receiver coils as in the present embodiment can be operated in the same article transport facility 100.

As shown in FIG. 4, the power receiver circuit is electrically connected to the pickup coil 4. The power receiver circuit is connected to an electric load and supplies electric power to the electric load. The electric load is, for example, the drive motor 14 for traveling as described above, the actuator for raising and lowering the article supporter, the actuator for driving the grippers for gripping the articles, or the drive circuits for the drive motor 14 and these actuators. A power storage device such as a battery may be connected to the power receiver circuit.

The power receiver circuit includes, for example, part of a resonator 5 including the pickup coil 4, a rectifier 45, and a power adjuster (not shown) such as a chopper or a regulator. In this example, the resonator 5 is a parallel circuit including the pickup coil 4 and a resonant capacitor 6. The resonator may be a series resonator including the capacitor connected in series to the pickup coil 4. The rectifier 45 is connected in parallel to the resonator 5 (resonant capacitor 6). The rectifier 45 is connected to the pickup coil 4 (the resonator 5) to rectify the alternating current and the alternating current voltage induced in the pickup coil 4 to a direct current and a direct current voltage. Although the rectifier 45 is a full-wave rectifier in the present embodiment, the rectifier 45 may also be a half-wave rectifier. Although not shown, at least one of an output portion for the rectifier 45 and an output portion for the power adjuster may include a smoothing capacitor for smoothing a pulsating component.

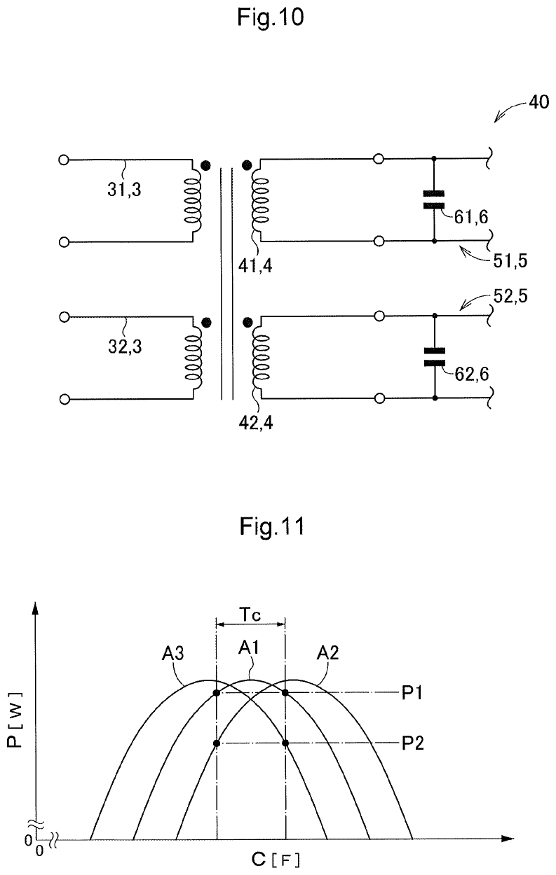

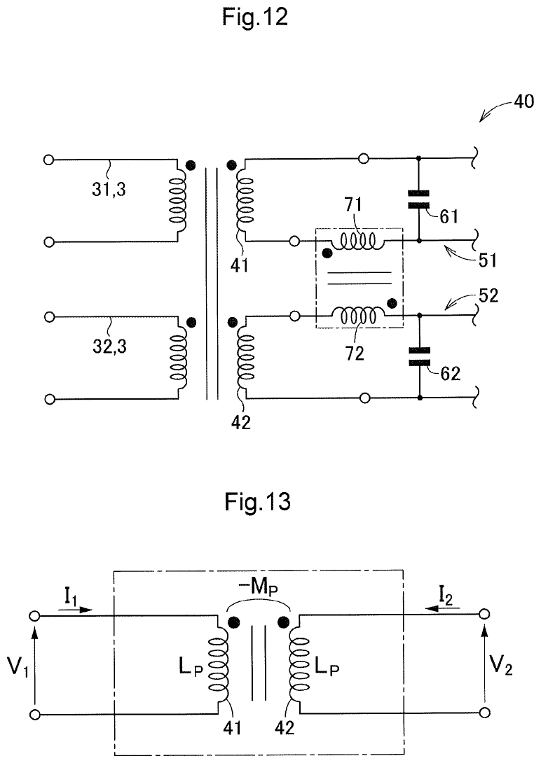

The resonator 5 illustrated in FIG. 4 has the same structure as a first resonator 51 including the first receiver coil 41 and a second resonator 52 including the second receiver coil 42 (refer to, for example, FIGS. 10 and 12). In the present embodiment, the first resonator 51 is a parallel resonator including the first receiver coil 41 and a first resonant capacitor 61. The second resonator 52 is a parallel resonator including the second receiver coil 42 and a second resonant capacitor 62.

The contactless power feeding system 1 according to the present embodiment uses the contactless power transmission technique using electromagnetic induction or magnetic resonance (magnetic field resonance) to feed electric power from the feed lines 3 to the article transport vehicle 10. As shown in FIG. 5, the contactless power feeding system 1 includes the feed lines 3 and power supplies 30 connected to the feed lines 3 to feed alternating currents to the feed lines 3. As illustrated in FIG. 1, the article transport facility 100 in the present embodiment is relatively large. To avoid lowering the power transmission efficiency or to prevent stoppage of the entire facility upon failure, the contactless power feeding system 1 includes multiple power feeding systems, rather than a single power feeding system, each including the feed line 3 and the power supply 30. In other words, multiple feed lines 3 (power feeding systems) are aligned in the travel direction Y. As shown in FIG. 1, the travel direction Y includes a linear direction as well as a curved direction along the travel path 20 in a portion in which the travel path 20 curves. The feed lines 3 (power feeding systems) are also aligned in the travel direction Y that is curved. One power feeding system feeds electric power to multiple article transport vehicles 10.

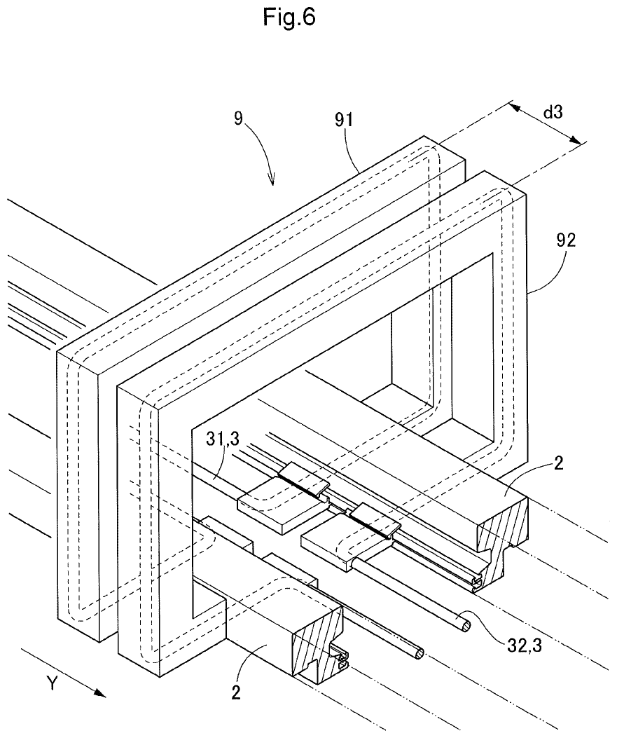

The article transport vehicles 10 switch the multiple power feeding systems one from another to continuously receive electric power and travel in the article transport facility 100. To travel smoothly, the article transport vehicles 10 may be stably powered at switch sections between the power feeding systems, or in other words, the feed lines 3. In this structure, the feed lines 3 adjacent to each other in the travel direction Y are arranged with a constant spacing (a feed line spacing d3 described later) between feed lines 3. More specifically, as shown in FIG. 6, the positional relationship between the feed lines 3 adjacent to each other in the travel direction Y is maintained with a switch unit 9 between the feed lines 3.

Any two feed lines 3 adjacent to each other in the travel direction Y are referred to as a first feed line 31 and a second feed line 32. The power supply 30 that supplies electric power to the first feed line 31 is referred to as a first power supply 33, and the power supply 30 that supplies electric power to the second feed line 32 is referred to as a second power supply 34. The feed line 3 before switching lines (the feed line 3 disposed rearward, or upstream, in the travel direction Y of the article transport vehicle 10) is herein referred to as the first feed line 31, and the feed line 3 after switching lines (the feed line 3 disposed frontward, or downstream, in the travel direction Y of the article transport vehicle 10) is herein referred to as the second feed line 32. The switch unit 9 includes a first switch unit 91 holding the first feed line 31 and a second switch unit 92 holding the second feed line 32. The first switch unit 91 and the second switch unit 92 are arranged with a predetermined spacing (unit spacing) in the travel direction Y. Thus, the first feed line 31 and the second feed line 32 are aligned adjacent to each other in the travel direction Y and are apart from each other by a distance (feed line spacing d3) based on the unit spacing.

As shown in FIG. 7, when a phase of an alternating current I₃₁ flowing through the first feed line 31 matches a phase of an alternating current I₃₂ flowing through the second feed line 32 with the switch unit 9 being between the feed lines, the electric power transmitted appears to be equivalent to the electric power transmitted through a single feed line 3. As described above with reference to FIG. 5, the multiple power feeding systems each receive alternating current power from a different power supply 30. The contactless power feeding system 1 thus often includes phase-locked loops for synchronizing alternating current phases between different power supplies 30. For example, as illustrated in FIG. 7, a phase-locked loop matches the phases of the current I₃₁ flowing through the first feed line 31 and the current I₃₂ flowing through the second feed line 32. However, large facilities include multiple power feeding systems arranged along the travel path 20 of the movable body such as the article transport vehicle 10, increasing the number of power supplies 30 to be synchronized. A greater number of power supplies 30 increases the number of phase-locked loops and wires between the phase-locked loops and the power supplies 30. This increases the cost of the phase-locked loops as well as the installation space for the phase-locked loops and the wires.

Thus, the contactless power feeding system 1 according to the present embodiment does not include any phase-locked loop. Each power supply 30 supplies, independently of other power supplies 30, an alternating current to the corresponding feed line 3 without synchronizing the phase of the alternating current with the phase of an alternating current output from the other power supply 30. For example, the first power supply 33 supplies, independently of the second power supply 34, an alternating current to the first feed line 31 without synchronizing the phase of the alternating current with the phase of an alternating current output from the second power supply 34 to the second feed line 32. The second power supply 34 supplies, independently of the first power supply 33, an alternating current to the second feed line 32 without synchronizing the phase of the alternating current with the phase of an alternating current output from the first power supply 33 to the first feed line 31.

Without the phase-locked loop, the currents flowing through the respective feed lines 3 adjacent to each other in the travel direction Y are likely to have a phase difference. For example, when the current I₃₁ flowing through the first feed line 31 and the current I₃₂ flowing through the second feed line 32 have a phase difference, the first feed line 31 and the second feed line 32 may interfere with each other, causing an interference current to flow through the first feed line 31 and the second feed line 32. The interference current may increase the current output from the power supply 30 connected to one of the feed lines 3, which increases the load on the power supply 30, or may decrease the current output from the power supply 30 based on its direction (phase). The interference current may also increase the voltage of the other feed line 3 based on its direction (phase), causing the voltage to exceed an allowable voltage of the power supply 30 connected to the feed line 3. Thus, the contactless power feeding system 1 without the phase-locked loops may have a greater unit spacing and a greater feed line spacing d3 than the contactless power feeding system 1 with the phase-locked loops. The greater feed line spacing d3 reduces interference between the adjacent feed lines 3.

However, the greater feed line spacing d3 may prevent continuous and smooth reception of electric power at the switch portion between the feed lines 3 adjacent to each other in the travel direction Y. For example, when the pickup coils 4 are arranged at the center of the switch portion in the travel direction Y, the power receiver 40 may not receive electric power from the feed lines 3. However, when the first receiver coil 41 and the second receiver coil 42 are aligned adjacent to each other in the travel direction Y as in the present embodiment, at least one of the receiver coils can easily face one of the feed lines 3, thus reducing the likelihood that power reception is interrupted.

In the present embodiment, the first receiver coil 41 and the second receiver coil 42 are aligned adjacent to each other in the travel direction Y between a pair of connecting shafts 17 in the article transport vehicle 10. The coil spacing d4 is thus relatively small. The distance between two feed lines 3 adjacent to each other in the travel direction Y (feed line spacing d3) is greater than the coil spacing d4. However, the feed line spacing d3 may be less than or equal to a length d2 of an arrangement area of the first receiver coil 41 and the second receiver coil 42 in the travel direction Y (refer to FIG. 3). To reliably receive electric power at the switch portion, the feed line spacing d3 may be less than or equal to a half of d2 or less than or equal to a length d1 of the arrangement area of the first receiver coil 41 or the second receiver coil 42 in the travel direction Y. The coil spacing d4 is defined by the power reception capability (including the specifications of the coil) of the power receiver 40 and the structure of the article transport vehicle 10. The feed line spacing d3 may be set based on the coil spacing d4 and the interference power between the adjacent feed lines 3. When the power receiver 40 includes the first receiver coil 41 and the second receiver coil 42 as in the present embodiment and one of the receiver coils disposed in a portion in which the adjacent feed lines 3 are spaced apart receives electric power from neither of the feed lines 3, the other receiver coil can receive electric power from one of the feed lines 3.

FIGS. 8 and 9 show the relationship between the feed lines 3 and the pickup coils 4 when the article transport vehicle 10 is at the switch portion between the feed lines 3. In this example, the first feed line 31 faces the first receiver coil 41, and the second feed line 32 faces the second receiver coil 42. In this case, the first feed line 31 and the first receiver coil 41 magnetically couple with each other, and the second feed line 32 and the second receiver coil 42 magnetically couple with each other, allowing power transmission from the feed lines 3 to the power receiver 40. When one of the first receiver coil 41 or the second receiver coil 42 is disposed at the center of the switch portion, the receiver coil may magnetically couple with neither of the feed lines 3 including the first feed line 31 and the second feed line 32. However, the other of the first receiver coil 41 or the second receiver coil 42 magnetically couples with one of the feed lines 3 including the first feed line 31 and the second feed line 32, allowing power transmission from the feed line 3 to the power receiver 40.

When the first receiver coil 41 and the second receiver coil 42 are arranged close to each other in the travel direction Y as in the present embodiment, magnetic coupling is likely to be established between the first receiver coil 41 and the second receiver coil 42, in addition to between the feed lines 3 and the pickup coils 4. This magnetic coupling can cause the first receiver coil 41 (the first resonator 51 including the first receiver coil 41) and the second receiver coil 42 (the second resonator 52 including the second receiver coil 42) to interfere with each other.

FIG. 8 shows that the phase of the current I₃₁ flowing through the first feed line 31 matches the phase of the current I₃₂ flowing through the second feed line 32, as illustrated in FIG. 7. When the pickup coils 4 are arranged across the switch portion between the feed lines 3 with the first feed line 31 facing the first receiver coil 41 and the second feed line 32 facing the second receiver coil 42, the phases of the currents induced in the first receiver coil 41 and the second receiver coil 42 also match. This is referred to as the state in which the currents of the first receiver coil 41 and the second receiver coil 42 adjacent to each other in the travel direction Y are in phase, or simply, being in phase. When the first receiver coil 41 and the second receiver coil 42 face the same feed line 3, the receiver coils are naturally in phase, and the phases of the currents induced in the first receiver coil 41 and the second receiver coil 42 match.

As shown in FIG. 8, when the currents I₃₁ and I₃₂ are in phase, the currents flow in opposite directions in a portion in which the first receiver coil 41 and the second receiver coil 42 face each other in the travel direction Y. Thus, a magnetic flux Φ1 induced by the current flowing through the first receiver coil 41 and a magnetic flux Φ2 induced by the current flowing through the second receiver coil 42 are in opposite directions. In other words, the magnetic flux Φ2 of the second receiver coil 42 interferes with the magnetic flux Φ1 of the first receiver coil 41 as viewed from the first receiver coil 41. Thus, an inductance of the first receiver coil 41 appears to be decreased. Similarly, the magnetic flux Φ1 of the first receiver coil 41 interferes with the magnetic flux Φ2 of the second receiver coil 42 as viewed from the second receiver coil 42. Thus, an inductance of the second receiver coil 42 appears to be decreased.

FIG. 9 shows that the phase of the current I₃₁ flowing through the first feed line 31 and the phase of the current I₃₂ flowing through the second feed line 32 are different by x radian (180 degrees), opposite to the state in FIG. 8. When the pickup coils 4 are arranged across the switch portion between the feed lines 3 with the first feed line 31 facing the first receiver coil 41 and the second feed line 32 facing the second receiver coil 42, the phases of the currents induced in the first receiver coil 41 and the second receiver coil 42 are also different by π radian (180 degrees). This is referred to as the state in which the currents of the first receiver coil 41 and the second receiver coil 42 adjacent to each other in the travel direction Y are out of phase, or simply, being out of phase.

As shown in FIG. 9, when the currents are out of phase, the currents flow in the same direction in a portion in which the first receiver coil 41 and the second receiver coil 42 face each other in the travel direction Y. Thus, the magnetic flux Φ1 induced by the current flowing through the first receiver coil 41 and the magnetic flux Φ2 induced by the current flowing through the second receiver coil 42 are in the same direction. In other words, the magnetic flux Φ2 of the second receiver coil 42 increases the magnetic flux Φ1 of the first receiver coil 41 as viewed from the first receiver coil 41. Thus, the inductance of the first receiver coil 41 appears to be increased. Similarly, the magnetic flux Φ1 of the first receiver coil 41 increases the magnetic flux Φ2 of the second receiver coil 42 as viewed from the second receiver coil 42. Thus, the inductance of the second receiver coil 42 appears to be increased.

FIG. 10 shows an equivalent circuit diagram of a power transmitter when the pickup coils 4 are arranged across the switch portion between the feed lines 3 with the first feed line 31 facing the first receiver coil 41 and the second feed line 32 facing the second receiver coil 42. FIG. 11 shows a frequency response of the resonator 5. The vertical axis indicates received power P received by the power receiver 40, and the horizontal axis indicates capacitance C of the resonant capacitor 6. FIG. 11 shows three curves indicating the frequency response in three states in which inductances L of the first receiver coil 41 and the second receiver coil 42 are changed by mutual interference. An inductance L is based on the phase difference between the currents flowing through the adjacent feed lines 3. FIG. 11 is thus a graph showing the frequency response of received power P in the power receiver 40 against the capacitance C of the resonant capacitor 6 for each phase difference between alternating currents flowing through the two feed lines 3 adjacent to each other in the travel direction Y.

The alternating current supplied from the power supplies 30 to the feed lines 3 has a fixed frequency, which is herein referred to as f. The resonator 5 resonates when Formula 1 below is satisfied, where L is the inductance of the pickup coil 4 and C is the capacitance of the resonant capacitor 6.

$$f = \frac{1}{2 π \sqrt{LC}} \qquad ( 1 )$$

In FIG. 11, curve A1 shows the frequency response when the inductances of the first receiver coil 41 and the second receiver coil 42 are not increased or decreased by mutual interference. This corresponds to the structure in which the pickup coil 4 is a single receiver coil without being separated into the first receiver coil 41 and the second receiver coil 42. In the graph, Tc indicates a tolerance of the capacitance C of the resonant capacitor 6. The minimum value of the rated received power P in the power receiver 40 is based on a tolerance Tc of the capacitance C of the resonant capacitor 6. In frequency response A1, the minimum value of the received power P is first received power P1 with the capacitance C of the resonant capacitor 6 corresponding to the minimum value and the maximum value within the tolerance Tc of the resonant capacitor 6.

Curve A2 shows the frequency response when the inductances of the first receiver coil 41 and the second receiver coil 42 are decreased by mutual interference. When the inductance L decreases in the resonator 5 (in Formula 1), the capacitance C satisfying a resonance condition increases with the frequency f being fixed. With the value of the resonant capacitor 6 being constant, the actual received power P in the power receiver 40 is based on the tolerance Tc of the capacitance C of the resonant capacitor 6. Frequency response A2 is shifted in a direction in which the capacitance C increases (to the right of the graph) with respect to frequency response A1. Thus, the minimum value of the received power P is second received power P2 with the capacitance C of the resonant capacitor 6 corresponding to the minimum value within the tolerance Tc of the resonant capacitor 6.

Curve A3 shows the frequency response when the inductances of the first receiver coil 41 and the second receiver coil 42 are increased by mutual interference. When the inductance L increases in the resonator 5 (in Formula 1), the capacitance C satisfying the resonance condition decreases with the frequency f being fixed. With the value of the resonant capacitor 6 being constant, the actual received power P in the power receiver 40 is based on the tolerance Tc of the capacitance C of the resonant capacitor 6. Frequency response A3 is shifted in a direction in which the capacitance C decreases (to the left of the graph) with respect to frequency response A1. Thus, the minimum value of the received power P is the second received power P2 with the capacitance C of the resonant capacitor 6 corresponding to the maximum value within the tolerance Tc of the resonant capacitor 6.

As described above, the received power P may be smaller when the first receiver coil 41 and the second receiver coil 42 interfere with each other (as in frequency responses A2 and A3) than when the first receiver coil 41 and the second receiver coil 42 do not interfere with each other (as in frequency response A1).

Thus, the first receiver coil 41 has a first interference-cancellation coil 71 connected in series, and the second receiver coil 42 has a second interference-cancellation coil 72 connected in series in the present embodiment, as shown in FIG. 12. The first interference-cancellation coil 71 and the second interference-cancellation coil 72 are disposed to magnetically couple with each other. The first interference-cancellation coil 71 and the second interference-cancellation coil 72 have, for example, the same electrical characteristics and dimensions. The first resonator 51 includes a first resonant capacitor 61 in parallel with the series circuit of the first receiver coil 41 and the first interference-cancellation coil 71. Similarly, the second resonator 52 includes a second resonant capacitor 62 in parallel with the series circuit of the second receiver coil 42 and the second interference-cancellation coil 72.

FIG. 13 shows an equivalent circuit including the first receiver coil 41 and the second receiver coil 42 that magnetically couple with each other without any interference-cancellation coil. A resonant voltage V₁ of the first receiver coil 41 is expressed by Formula 2, and a resonant voltage V₂ of the second receiver coil 42 is expressed by Formula 3 below, where L_{P} is a self-inductance of the first receiver coil 41 and the second receiver coil 42 (the first receiver coil 41 and the second receiver coil 42 are coils with the same specifications, and thus have the same value), M_{P} is a mutual inductance between the first receiver coil 41 and the second receiver coil 42, I₁ is a current flowing through the first receiver coil 41, I₂ is a current flowing through the second receiver coil 42, and 0 is a phase difference between I₁ and I₂.

V₁=ωL_{P}I₁−ωM_{P}I₂=ωL_{P}I₁−ωM_{P}I₁ cos θ=ω(L_{P}−M_{P} cos θ)I₁ (2)

V₂=ωL_{P}I₂−ωM_{P}I₁=ωL_{P}I₂−ωM_{P}I₂ cos θ=ω(L_{P}−M_{P} cos θ)I₂ (3)

When I₁ and I₂ are in phase, θ=0 and cos θ=1. Thus, Formulas 2 and 3 are Formulas 4 and 5 below respectively. As described above with reference to FIG. 8, the inductances of the first receiver coil 41 and the second receiver coil 42 appear to be decreased.

V₁=ω(L_{P}−M_{P} cos θ)I₁=ω(L_{P}−M_{P})I₁ (4)

V₂=ω(L_{P}−M_{P} cos θ)I₂=ω(L_{P}−M_{P})I₂ (5)

When I₁ and I₂ are out of phase, 0=π and cos θ=−1. Thus, Formulas 2 and 3 are Formulas 6 and 7 below respectively. As described above with reference to FIG. 9, the inductances of the first receiver coil 41 and the second receiver coil 42 appear to be increased.

V₁=ω(L_{P}−M_{P} cos θ)I₁=ω(L_{P}−M_{P})I₁ (6)

V₂=ω(L_{P}−M_{P} cos θ)I₂=ω(L_{P}−M_{P})I₂ (7)

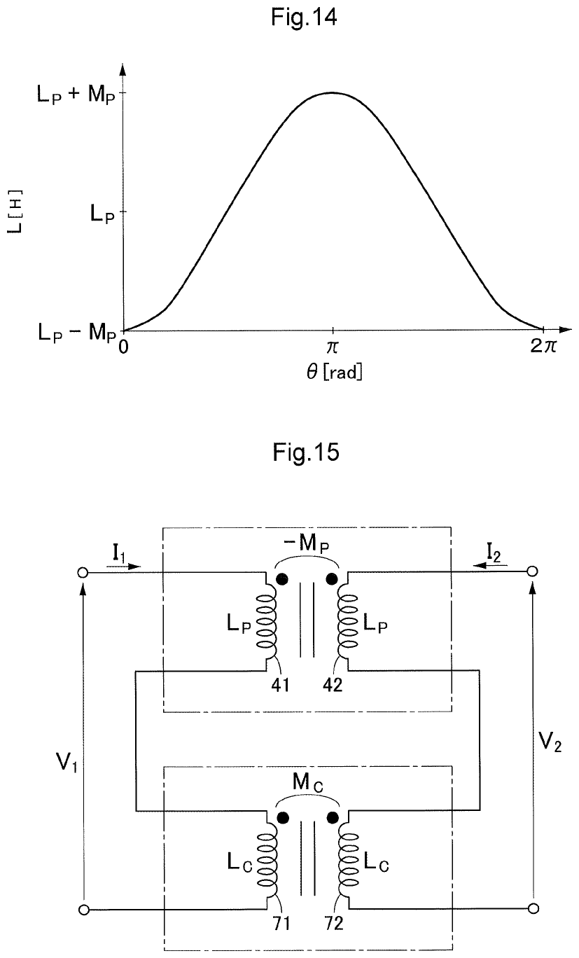

In other words, the inductances of the first receiver coil 41 and the second receiver coil 42 change based on the phase difference θ between I₁ and I₂ as shown in FIG. 14. In Formulas 2 and 3, when the phase difference θ is π/2 radian (90°) and cos θ=0, the inductances of the first receiver coil 41 and the second receiver coil 42 appear not to be increased or decreased.

FIG. 15 shows an equivalent circuit including the first receiver coil 41 and the second receiver coil 42 that magnetically couple with each other when the interference-cancellation coils are included. The resonant voltage V₁ of the first receiver coil 41 is expressed by Formula 8, and the resonant voltage V₂ of the second receiver coil 42 is expressed by Formula 9 below, where L_{C} is the self-inductance of the first interference-cancellation coil 71 and the second interference-cancellation coil 72 (the first interference-cancellation coil 71 and the second interference-cancellation coil 72 are coils with the same specifications, and thus have the same value), and M_{C} is the mutual inductance between the first interference-cancellation coil 71 and the second interference-cancellation coil 72.

V₁=ωL_{P}I₁−ωM_{P}I₂=ωL_{C}I₁−ωM_{C}I₂=ω(L_{P}−L_{C})I₁+ω(M_{C}−M_{P})I₂ (8)

V₂=ωL_{P}I₂−ωM_{P}I₁=ωL_{C}I₂−ωM_{C}I₁=ω(L_{P}−L_{C})I₂+ω(M_{C}−M_{P})I₁ (9)

In Formulas 8 and 9, the second term on the right-hand side including the value of the current flowing through the other one of the receiver coils is zero when the mutual inductance M_{C} between the first interference-cancellation coil 71 and the second interference-cancellation coil 72 is set to M_{C}=M_{P}. As shown in Formulas 2 and 3, when the second term on the right-hand side in Formulas 8 and 9 is expressed using the value of the current flowing through the corresponding receiver coil, the second term on the right-hand side includes cos θ as in Formulas 10 and 11 below.

V₁=ω(L_{P}+L_{C})I₁+ω(M_{C}−M_{P})I₂=ω(L_{P}+L_{C})I₁+ω(M_{C}−M_{P})I₁·cos θ (10)

V₂=ω(L_{P}+L_{C})I₂+ω(M_{C}−M_{P})I₁=ω(L_{P}+L_{C})I₂+ω(M_{C}−M_{P})I₂·cos θ (11)

When M_{C}=M_{P} is equal to zero, the second term on the right-hand side is zero, indicating that cos θ has no effect. In other words, the mutual inductance M_{C} between the first interference-cancellation coil 71 and the second interference-cancellation coil 72 is set to satisfy M_{C}=M_{P} to fix the inductances of the first receiver coil 41 and the second receiver coil 42 to L_{P}+L_{C} with or without the phase difference θ between I₁ and I₂.

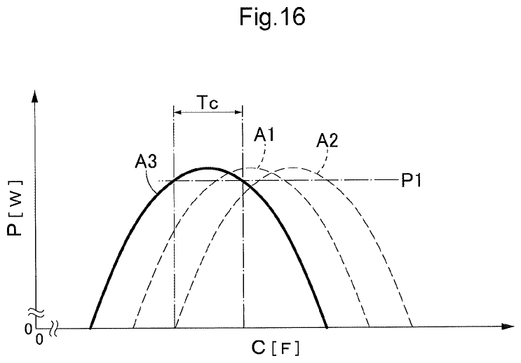

When the first interference-cancellation coil 71 and the second interference-cancellation coil 72 have a coupling coefficient of 1, L_{C}=M_{C}, then L_{P}+L_{C}=L_{P}+M_{P} because M_{C}=M_{P}. Thus, the frequency response of the received power P is aggregated into curve A3 with or without the phase difference θ between I₁ and I₂ as shown in FIG. 16. The resonant capacitor 6 has the capacitance C with a rated value (nominal value) set to a value corresponding to curve A3 (the maximum value of curve A3 or the value at the resonant point). This allows the rated received power P to be set to the same level as in curve A1 in FIG. 11 when the resonant capacitor 6 has a similar tolerance Tc.

When the first interference-cancellation coil 71 and the second interference-cancellation coil 72 have a coupling coefficient other than 1, the capacitance C of the resonant capacitor 6 may be set to the maximum value of the received power P based on the frequency response of the received power P when the inductances of the first receiver coil 41 and the second receiver coil 42 are expressed by L_{P}+L_{C}.

In the above embodiment, the contactless power feeding system 1 does not include any phase-locked loop. In other words, the contactless power feeding system 1 includes the power supplies 30 that supply alternating currents to the respective feed lines 3 aligned in the travel direction Y. Each power supply 30 supplies, independently of other power supplies 30, an alternating current to the corresponding feed line 3 without synchronizing the phase of the alternating current with the phase of an alternating current output from the other power supply 30. However, the present embodiment is also applicable to the contactless power feeding system 1 including the phase-locked loops.

When the phase-locked loops are used, the currents flowing through all the feed lines 3 may not fully match. For example, each power supply 30 includes an oscillator that has a tolerance. Thus, when the phases synchronize and match each other at a specific time, a slight shift in the cycle (a slight shift in frequency) may cause a phase difference. Such an error may also occur in other electronic and electrical devices in addition to oscillators. To accurately match the phases with a small error, each phase-locked loop may be structured using a highly accurate device. This is likely to increase the circuit size and cost. When the phase-locked loops are included, restricting the accuracy in exchange for reducing the cost may cause a phase difference. The present embodiment can be applied to reduce interference between the receiver coils resulting from the phase difference, independently of the accuracy of the phase-locked loop.

An overview of the contactless power feeding system described above is briefly provided below.

In one aspect, a contactless power feeding system includes a movable body including a power receiver, and a plurality of feed lines through each of which an alternating current flows. The plurality of feed lines are aligned in a travel direction along a travel path for the movable body. The contactless power feeding system feeds electric power contactlessly from the plurality of feed lines to the power receiver. The power receiver includes a first receiver coil, a second receiver coil, a first resonator, and a second resonator. The first receiver coil is disposed to magnetically couple with the plurality of feed lines. The second receiver coil is aligned adjacent to the first receiver coil in the travel direction and disposed to magnetically couple with the plurality of feed lines. The first resonator includes the first receiver coil and a first interference-cancellation coil connected in series to the first receiver coil. The second resonator includes the second receiver coil and a second interference-cancellation coil connected in series to the second receiver coil. The first interference-cancellation coil and the second interference-cancellation coil are disposed to magnetically couple with each other.

In this structure, when the movable body travels through a switch portion between the feed lines aligned in the travel direction and one of the first receiver coil or the second receiver coil being disposed between the adjacent feed lines cannot receive power through either of the feed lines, the other receiver coil is likely to receive power from one of the feed lines. This structure allows the power receiver to continuously receive power from a feed line when the movable body travels through the switch portion between the feed lines. However, when the first receiver coil and the second receiver coil are aligned in the travel direction, the first receiver coil and the second receiver coil may electromagnetically interfere with each other, changing the inductances of the first receiver coil and the second receiver coil and lowering power transmission efficiency. This structure including the first interference-cancellation coil and the second interference-cancellation coil that are disposed to magnetically couple with each other reduces electromagnetic interference between the first receiver coil and the second receiver coil, thus preventing a decrease in the power transmission efficiency.

In the contactless power feeding system, a mutual inductance between the first interference-cancellation coil and the second interference-cancellation coil may be substantially equal to a mutual inductance between the first receiver coil and the second receiver coil.

The mutual inductance between the first receiver coil and the second receiver coil, the mutual inductance between the first interference-cancellation coil and the second interference-cancellation coil, and the current flowing through the second receiver coil produce voltage that affects the resonant voltage of the first resonator. When the current flowing through a feed line for transmitting electric power to the first receiver coil and the current flowing through a feed line for transmitting power to the second receiver coil have a phase difference, the current flowing through the first receiver coil and the current flowing through the second receiver coil have a similar phase difference. When the first receiver coil and the second receiver coil magnetically couple with each other, the current flowing through the second receiver coil can be expressed using the current flowing through the first receiver coil and a cosine function (cos θ, where θ is the phase difference) of the phase difference. When the mutual inductance between the first receiver coil and the second receiver coil and the mutual inductance between the first interference-cancellation coil and the second interference-cancellation coil are the same, the voltage resulting from the current flowing through the second receiver coil (a current represented by a current flowing through the first receiver coil multiplied by cos θ) can be decreased to zero under some conditions. The same applies to the resonant voltage of the second resonator. More specifically, when the difference is small between the mutual inductance between the first receiver coil and the second receiver coil and the mutual inductance between the first interference-cancellation coil and the second interference-cancellation coil, the phase difference between the alternating currents flowing through the feed lines is less likely to affect the inductance of the resonator, allowing the inductance to remain constant with or without the phase difference. This reduces the effect on the resonant voltage, allowing the power transmission efficiency to be maintained easily. Thus, the mutual inductance between the first interference-cancellation coil and the second interference-cancellation coil may be substantially equal to the mutual inductance between the first receiver coil and the second receiver coil.

In the contactless power feeding system, two feed lines adjacent to each other in the travel direction among the plurality of feed lines may be apart from each other by a distance in the travel direction greater than a distance between the first receiver coil and the second receiver coil in the travel direction.

A phase difference between the alternating currents flowing through the two feed lines adjacent to each other in the travel direction may cause electromagnetic coupling of the feed lines. This may cause interference power to be transmitted from the first feed line to the second feed line. A shorter distance between the feed lines generates interference power more easily. In this structure, the distance between the feed lines in the travel direction is greater than the distance between the first receiver coil and the second receiver coil in the travel direction, thus easily reducing the interference power. In the contactless power feeding system with this structure, the first receiver coil and the second receiver coil are likely to cause more interference than the feed lines based on their separation distances. However, the interference between the receiver coils is canceled with the first interference-cancellation coil and the second interference-cancellation coil. The entire contactless power feeding system with this structure can thus maintain the power transmission efficiency to stably transmit electric power, although the alternating currents flowing through the multiple feed lines may have a phase difference.

The contactless power feeding system may further include a first power supply that supplies an alternating current to a first feed line among the plurality of feed lines aligned in the travel direction, and a second power supply that supplies an alternating current to a second feed line aligned with the first feed line in the travel direction among the plurality of feed lines. The first power supply may supply, independently of the second power supply, the alternating current to the first feed line without synchronizing a phase of the alternating current with a phase of the alternating current output from the second power supply. The second power supply may supply, independently of the first power supply, the alternating current to the second feed line without synchronizing a phase of the alternating current with a phase of the alternating current output from the first power supply.

The contactless power feeding system with this structure can reduce the effect of interference between the first receiver coil and the second receiver coil on the resonant voltage although the alternating currents flowing through the two feed lines adjacent to each other in the travel direction have a phase difference. The entire contactless power feeding system with this structure can thus maintain the power transmission efficiency to stably transmit electric power, although the alternating currents flowing through the multiple feed lines may have a phase difference.

What is claimed is:

1. A contactless power feeding system, comprising:
a movable body comprising a power receiver; and
a plurality of feed lines through each of which an alternating current flows, the plurality of feed lines aligned in a travel direction along a travel path for the movable body,
wherein the contactless power feeding system is configured to feed electric power contactlessly from the plurality of feed lines to the power receiver,
wherein the power receiver comprises:
a first receiver coil disposed to magnetically couple with the plurality of feed lines,
a second receiver coil aligned adjacent to the first receiver coil in the travel direction and disposed to magnetically couple with the plurality of feed lines,
a first resonator comprising the first receiver coil, the first resonator comprising a first interference-cancellation coil connected in series to the first receiver coil, and
a second resonator comprising the second receiver coil, the second resonator comprising a second interference-cancellation coil connected in series to the second receiver coil, and
wherein the first interference-cancellation coil and the second interference-cancellation coil is disposed to magnetically couple with each other.

2. The contactless power feeding system according to claim 1, wherein:
a mutual inductance between the first interference-cancellation coil and the second interference-cancellation coil is substantially equal to a mutual inductance between the first receiver coil and the second receiver coil.

3. The contactless power feeding system according to claim 1, wherein:
two feed lines adjacent to each other in the travel direction among the plurality of feed lines are apart from each other by a distance in the travel direction greater than a distance between the first receiver coil and the second receiver coil in the travel direction.

4. The contactless power feeding system according to claim 1, further comprising:
a first power supply configured to supply an alternating current to a first feed line among the plurality of feed lines aligned in the travel direction; and
a second power supply configured to supply an alternating current to a second feed line aligned with the first feed line in the travel direction among the plurality of feed lines,
wherein the first power supply supplies, independently of the second power supply, the alternating current to the first feed line without synchronizing a phase of the alternating current with a phase of the alternating current output from the second power supply, and
wherein the second power supply supplies, independently of the first power supply, the alternating current to the second feed line without synchronizing a phase of the alternating current with a phase of the alternating current output from the first power supply.
